(19) United States
(12) Patent Application Publication
(10) Pub. No.: US 2002/0129110 A1
(43) Pub. Date: Sep. 12, 2002

(54) Distributed event notification service

(76) Inventors: Ling-Zhong Liu, Ottawa (CA); Mark S. Wolff, Ottawa (CA)

Correspondence Address: MARKS & CLERK, P.O. BOX 957, STATION B, OTTAWA, ON, K1P 5S7, CA

(21) Appl. No.: 10/087,769

(22) Filed: Mar. 5, 2002

Related U.S. Application Data
(60) Provisional application No. 60/273,644, filed on Mar. 7, 2001.

(51) Int. Cl. G06F 15/16; G06F 9/46

(52) U.S. Cl. 709/206; 709/318

(57) ABSTRACT

The invention provides a distributed event notification mechanism that allows distributed applications to communicate with each other by generating events and receiving events through a distributed event notification service. An event manager coordinates activities between respective applications to ensure distribution regardless of the physical location of network elements. A naming service provides details of application location and configuration.

This invention claims the benefit of U.S. Provisional Application Ser. No. 60/273,644, filed Mar. 7, 2001.

### FIELD OF THE INVENTION

This invention relates to computer environments, and more particularly to event notification in a distributed computing environment.

### BACKGROUND AND PRIOR ART

The Applicant is aware of the following US patents, which serve as prior art in connection with this application:

U.S. Pat. No. 6,195,685, which issued Feb. 27, 2001 to Mukherjee et al;

U.S. Pat. No. 6,185,613, which issued Feb. 6, 2001 to Lawson et al;

U.S. Pat. No. 6,094,681, which issued Jul. 25, 2000 to Shaffer et al; and

U.S. Pat. No. 5,999,978, which issued Dec. 7, 1999 to Angal et al.

Event notification and distribution between computer systems connected together within a computer network allows a distributed computing environment to share information and resources. This method of event handling is generally achieved by having applications, which execute on the various computer systems, known herein as event producers (EPs), send events to applications also executing on the various computer systems, known herein as event consumers (ECs). An EP must know which ECs to send to, and ECs must know which EPs to receive from.

Although current event notification systems provide many benefits, there are several areas that can be improved on. Current event notification systems need the EP to know whether an EC is local (i.e. on the same computer system or subsystem), or whether the EC is remote (i.e. on a different computer system or subsystem). The EP will carry two separate lists: one for local ECs, and one for remote ECs. Therefore the EP behaves differently depending on whether the EC is local or remote. The same situation and usual implementation is true for the EC; it must know whether the EP is local or remote. An improvement would be to eliminate the requirement for the EP or EC to adapt its behavior based on whether the target EP or EC is local or remote.

Having local and remote concepts also means that all computer systems must contain accurate, current lists of local and remote EPs and ECs. If an EP or EC were to move its location (for example due to reconfiguration, or a component or network failure), all computer systems must update their local and remote lists before accurate event notification can resume. Automatic coordination of component location would also be an improvement.

Being able to support EP and/or EC duplication for application redundancy, for example, having the ability to seamlessly transfer responsibilities to another EP or EC in the event of component or network failure, would be an improvement to the art.

Another deficiency with prior art event notification systems is that, if the event notification is not deliverable (for example due to a network fault that may be temporary in nature), the EP normally receives only a response that the event was undeliverable. A solution that will try repeatedly to deliver an event would be an improvement to the art.

### SUMMARY OF THE INVENTION

The invention provides a distributed event notification mechanism that allows distributed applications to communicate with each other by generating and receiving the events.

The invention uses a distributed design rather than a centralized one. Neither a centralized nor a distributed database is required. The invention provides a very simple design for event delivery to the applications that are interested in the events.

The invention adds an EM (Event Manager) function above the EPs and ECs. The purpose of the EM is to abstract EP and EC location information, to provide redundant event operations, and to enhance event notification delivery.

The invention uses a naming service to find the application that is either the producer or the manager of the event. A naming service can be described, in one particular instance, as a storage database of application names and their locations. The naming service enables network components to connect together without regard for the specific physical locations or configurations of the network.

The invention uses a local name and a shared global name for each EM. Each EP uses event lists to maintain a list of ECs that are interested in the event.

The EM can be configured to send an event periodically and repeatedly until an acknowledgment is received, for example, when there are event delivery problems.

The invention allows the EPs and ECs to be moved from one node to another node without impacting the event delivery. It allows the event to be delivered by application name without regard for its location.

The invention allows for EP and EC applications to have redundant versions to provide event delivery to a standby application when the active application has failed or the network does not permit event delivery.

Therefore in accordance with a first broad aspect of the invention there is provided a system for event notification and distribution between applications in a distributed computer network comprising: a management function for managing location and event information for distribution between respective applications; and a naming service to enable respective applications to connect together.

In accordance with a second aspect of the invention there is provided a method of providing event notification distribution to applications in a distributed computing system, comprising: providing an event manager to deliver event information to applications having an interest in the information; and using a naming service to locate an application within the system that is either an event producer or an event consumer.

### BRIEF DESCRIPTION OF THE DRAWINGS

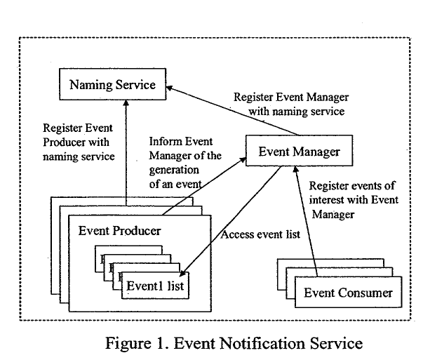

The invention will now be described in greater detail with reference to the attached drawing, wherein FIG. 1 is an illustration of an event notification service.

### DETAILED DESCRIPTION OF THE INVENTION

In a distributed computing environment, many computers/workstations, called nodes, are connected in a network; example, a LAN (Local Area Network). In such a distributed computing environment, different applications may share information and resources. It is necessary for applications to discover events/states occurring in other applications. Each EP maintains a list of ECs that are interested in any event it produces. The EP provides an interface for the EM to access the lists.

The invention uses an EM to receive, manage and deliver the events. The EM can be configured to send an event periodically and repeatedly until an acknowledgment is received. This feature makes the system more robust in the event of a hardware or software failure in the network.

A distributed naming service that provides name registration and a mechanism for the applications to find a named application is required. Operating systems that provide a naming service are widely available.

FIG. 1 shows the relationships among different applications involved in the event notification process.

The details of the design are described as follows:

1. Initialization:

An EM is created at each node, either during node initialization, or as needed following initialization. The EM registers its name with the naming service in the system. The naming service registers a LN (local name) for the local EM, and a GN (Global Name), for all other event managers in the distributed environment. Each EP is also registered with the naming service during initialization, or when it moves from one node to another.

2. Event registration:

When an EC is interested in an event created by a specific EP, it issues a request to the local EM. The request contains the event name, the EP name and the priority. The EM finds the EP through the naming service. If the EP is local to the node, the EM asks the EP to add the EC to the corresponding event list based on the priority specified in the request. The list is sorted in order of priority. If the EP is not local to the node, the EM sends a request to every EM in the distributed environment by using the GN. The EM on the remote node that contains the specified EP asks the EP to add the EC to the corresponding event list based on the priority specified in the request.

3. Event Delivery:

When an event is generated, the EP sends the event to the local EM. The EM generates a unique event ID for the event to prevent the same event from being processed twice. The event ID is unique within the entire distributed environment. One approach to creating a unique event ID is to combine a local event sequence number with the local node ID as the event ID. The EM gets the list of the events through an interface provided by the EP, and delivers the event to each EC in the list according to its priority.

4. Moving an EP from one node to another node:

When an EP is moved from one node to another node (the mechanism to move an application is beyond the scope of this invention), the application takes all event lists with it. It also de-registers itself with the EM in the old node before the move, and re-registers itself with the EM on the new node after the move. When the EP generates an event, it sends the event to the new EM. Event delivery proceeds as described in 3.

5. Moving an EC from one node to another node:

Moving an EC (the mechanism to move an application is beyond the scope of this invention) starts with the EC de-registering with the EM in the old node before the move, and re-registering with the EM on the new node after the move. EC does not re-register the events it has registered with the EM in the old node. If the EC wants to register a new event, it does so with the event manager in the new node.

6. Increasing the robustness of event notification:

When the EP registers with the EM, it can request that the EM try repeatedly to deliver an event if a delivery problem occurs, before responding that the event was undeliverable. Additionally a limit may be specified for the number of attempted repeats.

7. Providing redundant EP:

The EM can create redundant EPs, possibly to increase the reliability of the network. Because the EC registers only the EPs it is interested in with the local EM, the EM can hide the existence of multiple EPs. Each EP is able to provide the same event service to an EC; service is maintained even in the event of failure of one of the EPs. The mechanism to coordinate the operation of more than one EP is beyond the scope of this invention.

8. Providing redundant EC:

The EM can create redundant ECs, possibly to increase the reliability of the network. Because the EM provides EC registration and event delivery service on behalf of the EPs, the EP is not concerned with whether there are one or more ECs. The EM can hide the existence of multiple ECs, each EC being able to receive the same event service from an EP. In the event of a failure of one of the ECs, the event information is still successfully received. The mechanism to coordinate the operation of more than one EC is beyond the scope of this invention.

Although particular embodiments of the invention have been described and illustrated it will be apparent to one skilled in the art that numerous changes can be implemented with departing from the basic concept. It is to be understood, however, that such changes will fall within the full scope of the invention as defined by the appended claims.

We claim:

1. A system for event notification and distribution between applications in a distributed computer network comprising:
a management function for managing location and event information for distribution between respective applications; and
a naming service to enable respective applications to connect together.

2. The system as defined in claim 1 wherein said respective applications are executed on nodes connected in the network.

3. The system as defined in claim 2 wherein applications executed on said nodes represent event consumers (EC) and event producers (EP).

4. The system as defined in claim 3 wherein said event consumers and said event producers are either local or remote.

5. The system as defined in claim 4 wherein said management function ensures automatic coordination between events on local and remote event consumers and event producers.

6. The system as defined in claim 5 wherein said management function is an event manager that interfaces between event producers and event consumers to track location information respecting event producers and event consumers.

7. The system as defined in claim 5 wherein said management function is an event manager that interfaces between event producers and event consumers to provide redundant event operations.

8. The system as defined in claim 5 wherein said management function is an event manager that interfaces between event producers and event consumers to enhance event notification delivery.

9. The system as defined in claim 5 wherein said management function is an event manager that has both a local name and a shared global name.

10. The system as defined in claim 5 wherein said management function is an event manager that is configured to send an event periodically and until an acknowledgement is received from an event consumer.

11. The system as defined in claim 3 wherein each event producer maintains a list of all event consumers wishing to receive an event notification.

12. The system as defined in claim 3 wherein said event producers and said event consumers have redundant versions to provide event delivery to stand by applications when the network does not permit event delivery to primary event producers and event consumers.

13. A method of providing event notification distribution to applications in a distributed computing system, comprising:
providing an event manager to deliver event information to applications having an interest in the information; and
using a naming service to locate an application within the system that is either an event producer or an event consumer.

14. The method as defined in claim 13 wherein said distributed computing system has numerous nodes in which multiple applications share information and resources.

15. The method as defined in claim 13 wherein said event manager is created at each node, registers with said naming service and obtains a local name and a global name.

16. The method as defined in claim 13, wherein the event manager is configured to send an event periodically until a reply is received from an intended recipient.

17. A system for distributing event notifications to respective applications in a distributed computing network comprising:
an event producer for generating an event notification;
an event consumer for receiving said event notification;
an event manager for receiving information from said event producer regarding generation of said event notification and for receiving information from said event consumer regarding event notifications which it would like to receive; and
a naming service which maintains information regarding location and configuration of said event producers and said event consumers;
whereby event notifications are distributed to network elements regardless of physical location.

18. The system as defined in claim 17 wherein said naming service is a database containing application names and location.

19. The system as defined in claim 17 wherein said network element are nodes within said distributed computing network
